(19) United States
(12) Patent Application Publication
(10) Pub. No.: US 2014/0182342 A1
(43) Pub. Date: Jul. 3, 2014

(54) SAFETY LOCK FOR DOORS

(71) Applicants: ALEXANDER KLEINER, QIRYAT GAT (IL); GRIGORY ORENBAKH, QIRYAT GAT (IL)

(72) Inventors: ALEXANDER KLEINER, QIRYAT GAT (IL); GRIGORY ORENBAKH, QIRYAT GAT (IL)

(21) Appl. No.: 14/132,139

(22) Filed: Dec. 18, 2013

(30) Foreign Application Priority Data
Jan. 2, 2013 (IL) IL2013/224099

(51) Int. Cl. E05C 1/02; E05F 3/00

(52) U.S. Cl. CPC E05C 1/02; E05F 3/00
USPC 70/93; 292/137

(57) ABSTRACT

The present invention, in some embodiments thereof, provides a safety lock for enabling partial opening of a door.
The safety lock includes:
   (i) a first lock member configured for being installed at an opening of a doorframe of the door, wherein the first lock member includes a movable element and at least one track for allowing the movable element to slide there through, wherein the movable element comprises an opening.
   (ii) a second lock member comprising a protruding section, wherein the protruding section is configured for being inserted into the opening of the first lock member, installed at the doorframe, for allowing thereby pulling of the movable element for allowing partial opening of the door and removing the protruding section from the opening for opening the door.

### FIELD OF THE INVENTION

The present invention generally relates to safety lock systems and devices and particularly to safety lock systems and devices that allow holding the door in a semi-open position in respect to a doorframe leaving a limited open aperture between the door and the doorframe.

### BACKGROUND OF THE INVENTION

Security door chains are often used as an added security means for allowing opening a door secured thereby to a “semi-open” position, in which the door is held slightly open to allow the person inside the premises secured by the door to see and communicate with a person located outside the door while still preventing that person from entering the premises. Other lock systems are used for the same purpose using, for example, a lock that has a grooved member designed to be installed near the door (over the doorframe or wall that is adjacent to the door) and a rotatable protruding member installed over the door for allowing the protruding member to slide within the groove for opening the door to a semi-open position and releasing the lock by rotating the protruding member until it can be removed from its interlock with the grooved member.

Another known system for allowing a user to open the door to a semi-open position is illustrated in FIGS. 1A-1C, which show a lock member 20, which is only one part of the safety lock configured to be installed in the doorframe 30, where the lock member 20 includes a movable member 22 that can be pulled by a protruding section (not shown) installed at the door. The protruding section is inserted into an opening 24 in the movable member 22 and pulls it until it reaches its maximal pulling length, limited by the mechanism to a predefined length leaving a corresponding limited opening aperture of the door. This means that the full opening position of the safety lock only leaves a predefined limited space between the door and the doorframe 30 allowing a person inside the room, for example, to be able to slightly open the door for viewing the other side of the room while still preventing a person from entering through that door.

As shown in FIGS. 1B and 1C the prior art lock member 22 includes a designated groove 26 having a limited length and the lock member 20 includes a first and second plates 23 and 25 respectively, configured for holding the movable member 22 therebetween in a manner that allows it to be pulled and retrieve while limiting its movement by allowing it to be pulled to a predefined limited length. To do so a protruding pin 27 is installed at the first or second plates 23/25 inserted through the groove 26 of the movable member 22 where the pin is blocked by the groove's 26 walls allowing the length of the groove 26 to define the span of the movable member 22. The first plate 23 includes a socket 21 configured for receiving the protruding section (not shown) installed at the doorframe. This safety lock design requires installation of the lock member 20 inside the doorframe 30 before the doorframe 30 is affixed to a wall or removing of an already installed doorframe and then attaching the lock member 22 therein and for creating an opening for the movable member 22 to allow it to protrude externally from the doorframe 30 when pulled. This makes installation of this product cumbersome and expensive. Once the lock member 20 is installed inside the doorframe 30, it is very difficult to remove it for fixing it or replacing its parts as it again requires removing the entire doorframe 30 from the wall.

### SUMMARY OF THE INVENTION

The present invention, in some embodiments thereof, provides a safety lock for enabling partial opening of a door. The safety lock includes: (i) a first lock member configured for being installed at an opening of a doorframe of the door, wherein the first lock member includes a movable element and at least one track for allowing the movable element to slide therethrough, wherein the movable element comprises an opening; and (ii) a second lock member comprising a protruding section, wherein the protruding section is configured for being inserted into the opening of the first lock member, installed at the doorframe, for allowing thereby pulling of the movable element for allowing partial opening of the door and removing the protruding section from the opening for opening the door. According to these embodiments, each track is separable from the movable element to allow installation of the first lock member inside the doorframe by inserting each of them separately through the opening of the doorframe.

Optionally, the movable element includes at least one stopper configured for preventing said movable element from completely being removed from the doorframe.

Additionally or alternatively, the safety lock further includes a transmission mechanism configured for pulling and pushing of the second lock member for locking and unlocking of the safety lock.

According to some embodiments, the transmission mechanism comprises a key lock. An optionally also includes a set of cogwheels for allowing transforming a rotational movement of a key rotating the key lock into linear movement of the second lock member for locking and unlocking the safety lock.

According to some embodiments of the invention, the safety lock further includes a holding base that holds the second lock member and the transmission mechanism thereover, wherein the holding base is configured to be installed inside the door.

Optionally, the first lock member includes two tracks each meshing with a side of the movable element for allowing the movable element to slide therethrough. Each track may optionally be fastened to the doorframe via a fastener.

According to some embodiments, the movable element fully covers the opening in the doorframe when the door is closed.

According to other aspects of the present invention, there is provided a safety lock for enabling partial opening of a door, wherein the safety lock includes: (i) a first lock member configured for being installed at an opening of a doorframe of the door, wherein the first lock member includes a movable element and at least one track for allowing the movable element to slide therethrough, wherein the movable element includes an opening; (ii) a second lock member comprising a protruding section connected to a base section of the second lock member, wherein the protruding section is configured for being inserted into the opening of the first lock member, installed at the doorframe, for allowing thereby pulling of the movable element for allowing partial opening of the safety lock and removing the protruding section from this opening for opening the safety lock; and (iii) a transmission mechanism configured for pulling and pushing the second lock member for locking and unlocking of the safety lock. Each track is separable from the movable element to allow installation of the first lock member inside the doorframe by inserting each of the movable element and the tracks separately through the opening thereof.

### BRIEF DESCRIPTION OF THE DRAWINGS

FIG. 1A is an illustration of a lock member component of a known in the art safety lock that includes installed at a doorframe.

FIG. 1B is an illustration of the lock member component of the known in the art safety lock.

FIG. 1C is an illustration of a movable member of the lock member component of the known in the art safety lock.

FIG. 2 shows an isometric view of a safety lock, according to some embodiments of the present invention.

FIG. 3 shows an exploded view of a first lock member of the safety lock, according to some embodiments of the present invention.

FIG. 4 shows a view of the assembled first lock member of the safety lock, according to some embodiments of the present invention.

FIG. 5 shows how a second lock member of the safety lock interlocks with the first lock member for allowing pulling thereof to a limited partial opened position, according to some embodiments of the present invention.

FIG. 6A shows the second lock member and a transmission mechanism configured for moving the second lock member, where these two components are in a protruding position, in which a protruding section of the second lock member protrudes from a surface that is configured for interfacing the door, according to some embodiments of the invention.

FIG. 6B shows the second lock member and the transmission mechanism in a position in which the protruding section is in a non-protruding position coplanar with the surface of an elongated plate configured for interfacing the door, according to some embodiments of the invention.

FIG. 7 shows the safety lock installed at a doorframe, according to some embodiments of the invention.

FIG. 8 shows how an opening in the doorframe is created, optionally after the doorframe is affixed to a wall to accommodate the safety lock therein, according to some embodiments of the invention.

FIG. 9 shows a rear view of the doorframe and the safety lock installed therein, according to some embodiments of the invention.

FIG. 10 shows a cross sectional view of the doorframe and the first lock member of the safety lock installed therein as well as the door having the second lock member installed therein, according to some embodiments of the invention.

FIG. 11A shows an elevated view of the doorframe and the first lock member of the safety lock installed therein as well as the door having the second lock member installed therein, according to some embodiments of the invention.

FIG. 11B shows an elevated semi-transparent view of the doorframe and the first lock member of the safety lock installed therein, according to some embodiments of the invention.

FIG. 12 shows the safety lock in a partially open position in which the movable element of the first lock member is pulled to its maximal length, according to some embodiments of the invention.

FIG. 13 shows the safety lock in a fully locked position in which the door cannot be opened to a semi-open position, according to some embodiments of the invention.

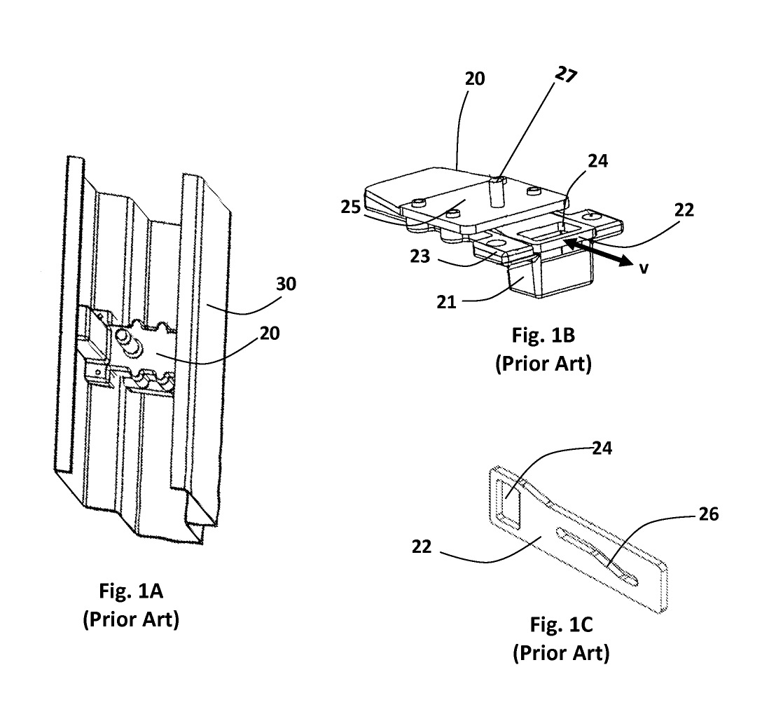

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides a safety lock for enabling partial opening of a door in a manner that the door can be held in a partial open position preventing a person from crossing therethrough while allowing a person on the other side of the door to be able to see through a narrow opening created by this partial opening. According to some embodiments of the invention, the safety lock includes: (a) a first lock member configured for being installed at a doorframe of the door, where the first lock member includes a movable element and at least two tracks for allowing this movable element to slide therebetween; (b) a second lock member including a protruding section integrally connected to a base section of the second lock member, where the protruding section is configured for being inserted into an opening of the first lock member for allowing thereby pulling it for allowing the partial opening thereof and removing (retracting by pulling back) the protruding section from this opening for opening the safety lock; and (c) a transmission mechanism configured for pulling and pushing the second lock member for locking and unlocking of the safety lock. The pulling and pushing may be done manually or automatically.

According to some embodiments of the invention, the first lock member includes two removable tracks that are designed to allow the movable element of the first lock member to slide therethrough for protruding out of the doorframe it is installed in and retracting back into a niche in the doorframe to a non-protruding position. These tracks are removably connected to the doorframe and are separable from the movable element to first allow the movable element to freely slide thereby as well as to allow installing the first lock member inside the doorframe without requiring the doorframe to be separated from the wall it should be installed over. Since these three parts (the tracks and movable elements) are separable from one another the first lock member can be installed in the doorframe when the doorframe is already affixed to a wall without requiring removal of the doorframe from the wall. This can be done by creating a niche (opening) inside the doorframe; then inserting the tracks into the doorframe and fastening them thereto (e.g. by screwing them to the doorframe) by sliding them over the movable element, and then inserting the movable element into this niche. The movable element may include one or more stoppers (such as screw bolts) for preventing the movable element from being completely pulled out of the doorframe niche. The location of these stoppers over the movable element and the length of the movable element determine the span of the partial opening of the door (defined in this document also as the door's “partial-opening aperture”). According to some embodiments, the location of the stopper(s) can be adjusted to adjust the partial opening aperture to the user's desire in an easy and comfortable manner, for example by screwing the bolt stopper at a desired location over the movable element.

According to some embodiments of the present invention, the transmission mechanism is a mechanical mechanism including multiple meshing cogwheels (e.g. gears) and a key-lock mechanism for rotating these cogwheels, where this gear-set is configured to transform the rotational movement to a linear movement of the second lock member installed at the door. Once linearly moved by the transmission mechanism, the second lock member (which includes a protruding section) can be pushed to protrude from the door, where the protruding section is located such that it is inserted into an opening at the movable element of the first lock member. This happens when the door is closed, meaning when the door interfaces the doorframe such that the door and the doorframe are substantially perpendicular to one another. In the locked position, when the door is open (rotated over a pivot thereof in respect to another doorframe parallel to the one the first lock member is installed to) the protruding section of the second lock member pulls the movable element of the first lock member until it reaches its maximal length and held by its stopper(s) to form the partially open position of the door.

The components are configured for easy installation and therefore also enable easy replacement of each one thereof as they do not require removal of the doorframe or the door for installation or replacement thereof

In the semi-open position that allows partial opening of the door leaving a preset aperture span between the doorframe and the door, the second lock member having a protruding section, is a position in which the protruding section is still held inside the doorframe (protruding through openings of the doorframe and first lock member). This configuration allows using only a single opening at the doorframe for installing the first lock member of the safety lock.

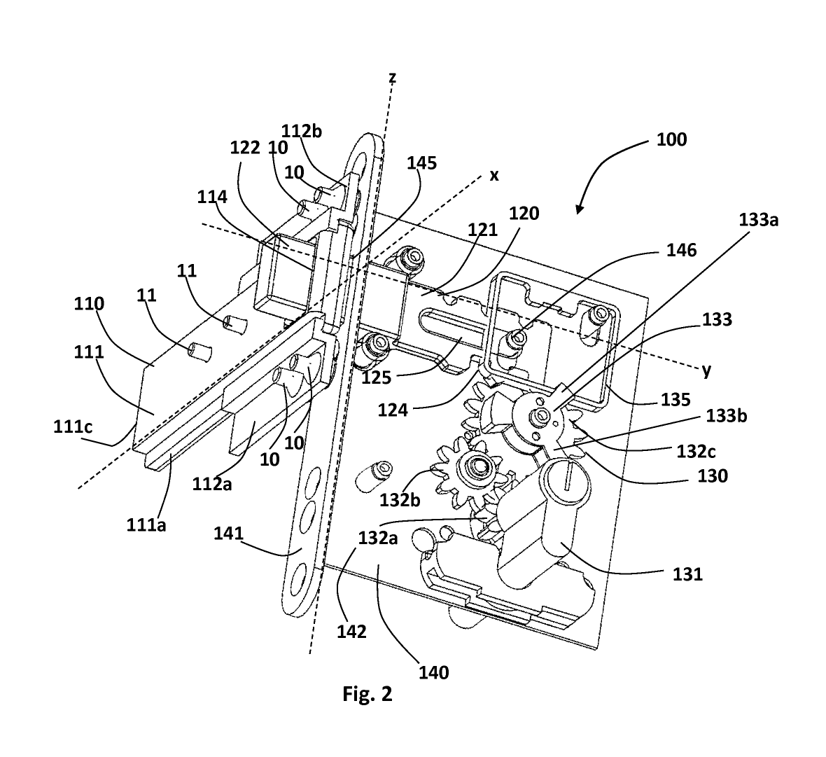

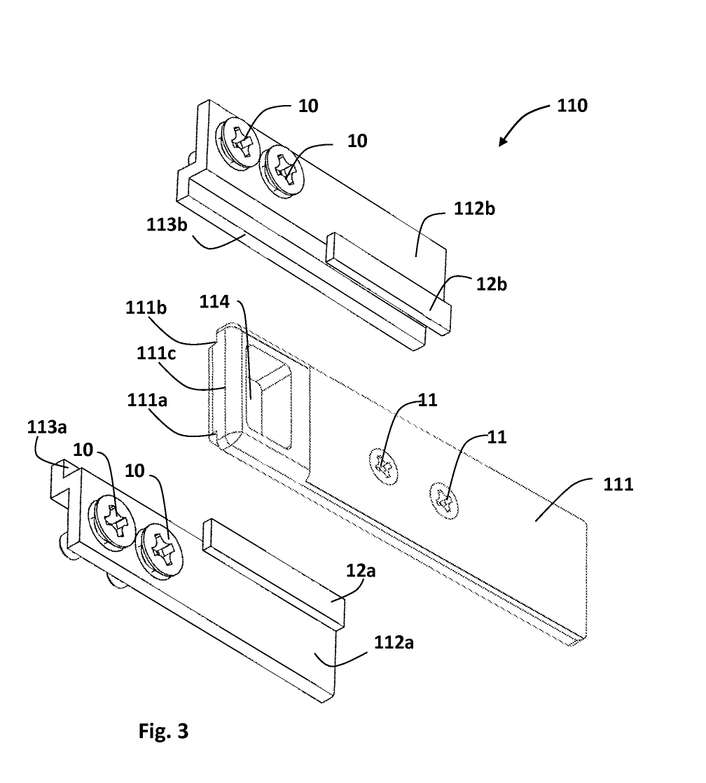

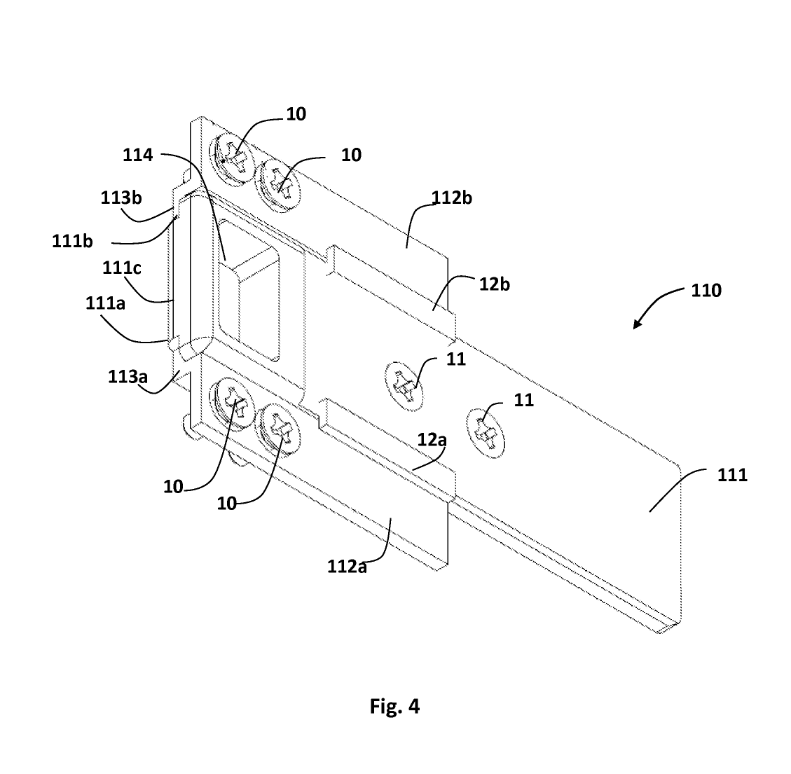

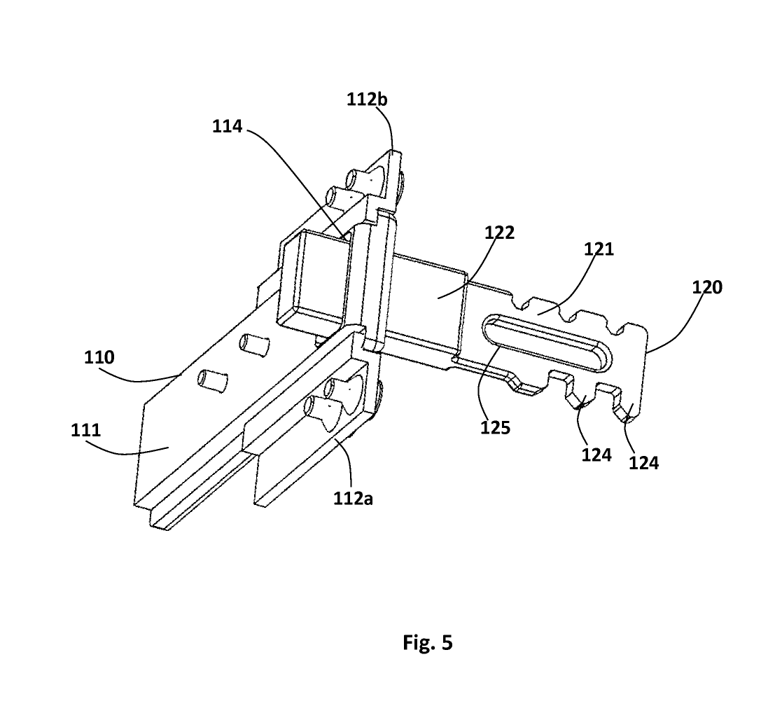

Reference is now made to FIG. 2, schematically illustrating a safety lock 100, according to some embodiments of the invention. The safety lock 100, according to these embodiments, includes a first lock member 110, a second lock member 120, and a transmission mechanism 130 that is held by a holding base 140. FIGS. 3-4 show the first lock member 110 in details and FIG. 5 shows how the first and second lock members 110-120 interlock, according to some embodiments of the invention.

The first lock member 100 includes a movable element 111 and two slidable tracks 112a and 112b through which the movable element 111 can slide. The tracks 112a-112b are separable from the movable element 111 and are not affixed thereto so that they can be separately installed into a designated niche in a respective doorframe in which the first lock member 110 is to be installed. As explained above, this allows installing the first lock member 110 inside the doorframe without requiring removing the doorframe from the wall allowing installing the safety lock 100 to an already installed door-set which includes at least two parallel doorframes and a door pivotally connected to one of the doorframes, where the first lock member 110 is configured to be installed at the other doorframe which the door interfaces when closing thereof (and not to the doorframe that connects to the door in a pivotal manner). The first and second tracks 112a-112b can be connected to a doorframe through fasteners such as screws 10.

As shown in FIGS. 2-5, the movable element 111 has a rectangular opening 114 and two stoppers 11 (which in this case are screw bolts) for limiting the movement span of the movable element 111 from the doorframe when pulled by the second lock member 120. The second lock member 120 includes a protruding section 122 and a base section 121 integrally connected to the protruding section 122, where the base section 121 has a groove 125 opening therein. In these illustrated examples the protruding section 122 is rectangular, however the protruding section may be of any shape such as rounded elliptic or any other provided that the opening 114 of the first lock member 110 is adapted in size and shape to receive the protruding section 122 therethrough.

According to some embodiments, as illustrated in FIG. 2, the transmission mechanism 130 includes three cogwheels: a first cogwheel 132a, a second cogwheel 132b and a third cogwheel 132c having a rotatable element 133 coaxially connecting thereto and a key lock 131. The first cogwheel 132a is rotatable by rotating the key lock 131 (using a designated key thereof) and it rotates the second cogwheel 132b which transmits rotational movement to the third cogwheel 132c and the rotatable element 133 coaxially connected thereto. The third cogwheel 132c meshes with teeth 124 of the base section 121 for mechanically transforming the rotational movement of the rotatable element 133 to a linear movement of the second lock member 120 altogether for pushing the protruding section 122 thereof outwardly from the door or (when rotated to the other direction) for retracting the protruding section 122 to anon-protruding positioning thereof by pulling the second lock member 120 backwards into the door in which it is installed. The rotatable element 133 includes at least two teeth 133a and 133b, where the first tooth 133a is located and configured to allow half turning of the key in the key lock 131 to rotate the upper tooth 133a via the cogwheel set, for linearly moving the protruding element 122 by linearly moving the groove 125 in respect to the pin 146 to only a portion of the full distance it is designed to be moved along the groove 125 (given the length of the groove 125) and to move it to a full locking position for locking the door completely when further rotating the key by having the lower tooth 133b engaging the pin 146 when the key is fully rotated. This configuration allows the safety lock 100 to serve both as a regular door lock preventing the door from opening when in a full locked position as well as a safety device that allows the semi-opened position of the door for allowing holding the door partially opened.

The rotatable element 133 has a number of protruding sections (teeth) that can interlock with a frame 135 for defining several different protruding section lengths of the protruding section 122.

The holding base 140 holds the cogwheels 132a-123c and key lock 131 as well as a pin 146 that limits the span of the linear movement of the second lock member 120. The holding base 140 also includes a holding plate 142 and an elongated plate 141 perpendicularly connected thereto. The holding plate 142 over which the cogwheels 132a-132c, pin 146 and key lock 131 are installed is inserted into a door to be held therein, where the elongated plate 141 is positioned over an external surface of the door that is configured for interfacing the doorframe when the door is closed.

As illustrated in FIG. 2, the elongated plate 141 includes an opening 145 for allowing the protruding section 122 of the second lock member 120 to protrude therefrom for interlocking with the movable element 111 of the first lock member 110.

The safety lock 100 is designed such that when a user locks it by rotating a key inside the key lock 131 to a predefined locking rotational direction, when the door is closed and interfaces the doorframe in which the first lock member 110 is installed, the protruding section 122 of the second lock member 120 protrudes and therefore inserted onto the opening 114 of the movable element 111 and therefore interlocks therewith. When the user then opens the door the door is only open to a limited partial aperture since the protruding section 122 pulls the movable element 111 until reaching its maximal length allowing the user to view what is outside this door but still preventing the door from being fully open and therefore preventing other people from entering therethrough.

According to some embodiments of the invention, the movable element 111 includes three sections integrally connected to one another: two external sections 111a and 111b and a middle section 111c, as shown in FIGS. 2-5. Each of the external sections 111a-111b includes a recess over which the respective first or second track 112a/112b can slide. Each track 112a/112b has a matching “Z” shaped recess 113a and 113b respectively, for meshing with the recess of the respective external section 111a/111b as shown in FIGS. 3-4. Optionally, as shown in FIGS. 2-5, each track 112a/112b includes a cover element 12a/12b for stabilizing the movable element 111 when slid through these tracks 112a/112b by preventing the tracks 112a/112b from tilting when the movable element 111 is slid therethrough.

It is clear from FIG. 2 that the first and second lock members 110 and 120, respectively, are substantially perpendicular to one another to allow the protruding section 122 to enter (interlock with) the movable element 111.

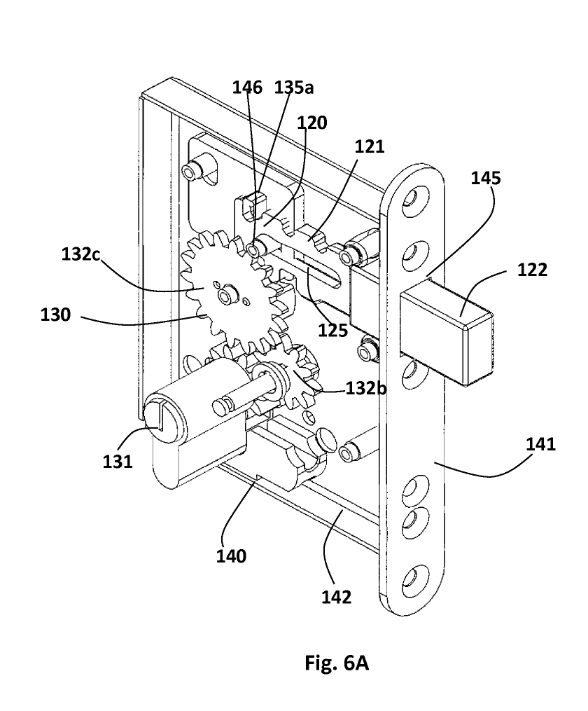

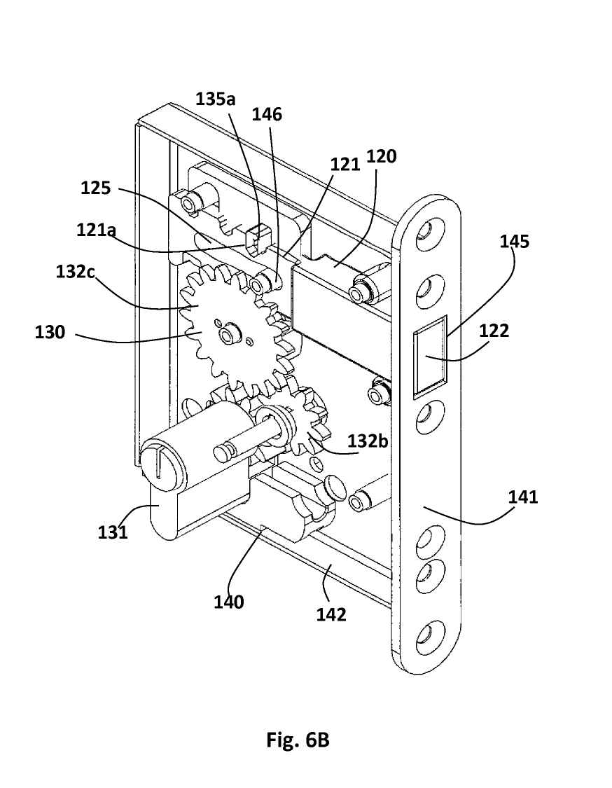

FIGS. 6A and 6B show the second lock member 120 installed over the holding member 140 and the transmission mechanism 130 thereof in a locked and unlocked positions respectively. In the locked position shown in FIG. 6A, the transmission mechanism 130 moved the second lock member 120 to a position in which its protruding section 122 protrudes from the elongated plate 141 through it opening 145 and the pin 146 is located at the edge of the groove 125. In the unlocked position shown in FIG. 6B, the transmission mechanism 130 moved the second lock member 120 to a position in which its protruding section 122 does not protrude from the elongated plate 141 and is coplanar therewith, where in this position the pin 146 is located at the opposite edge of the groove 125. It is also clear from FIGS. 6A and 6B that the safety lock 100 also includes a projection 135a located above the base section 121, where the base section 121 has one or more depressions such as depression 121a for interlocking with the projection 135a to further secure the second member 120 for preventing it from being pulled completely out of the door through the opening 145.

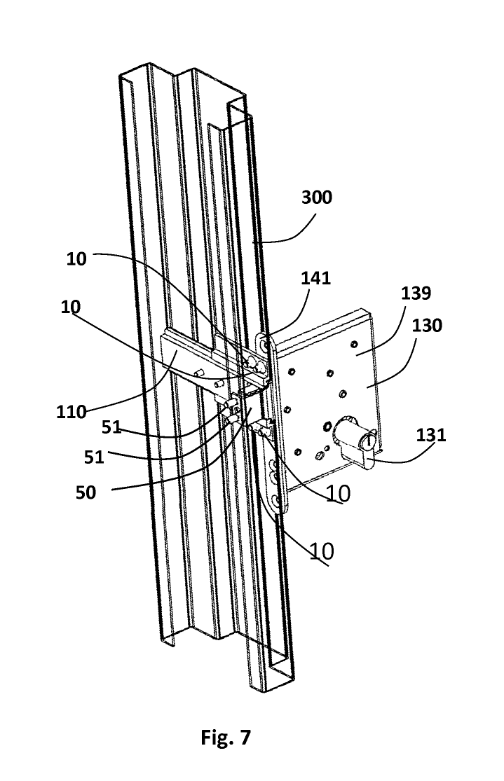

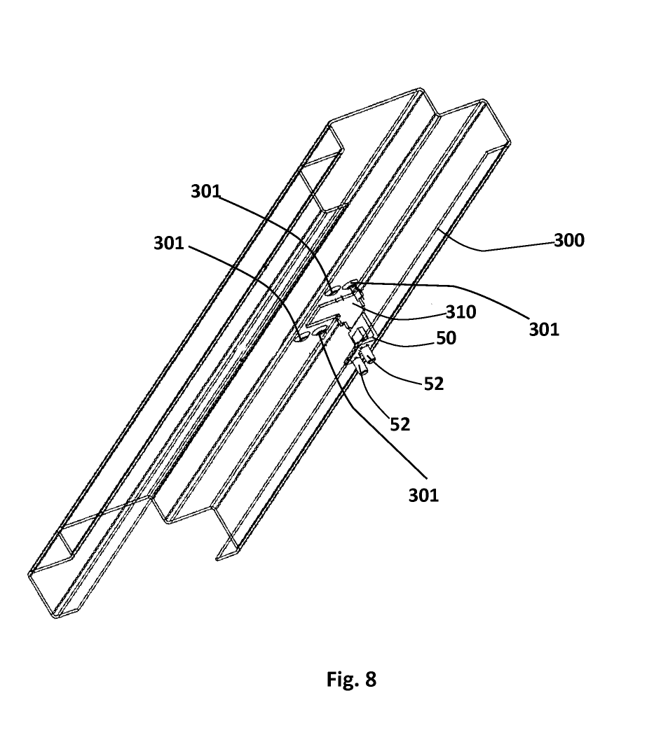

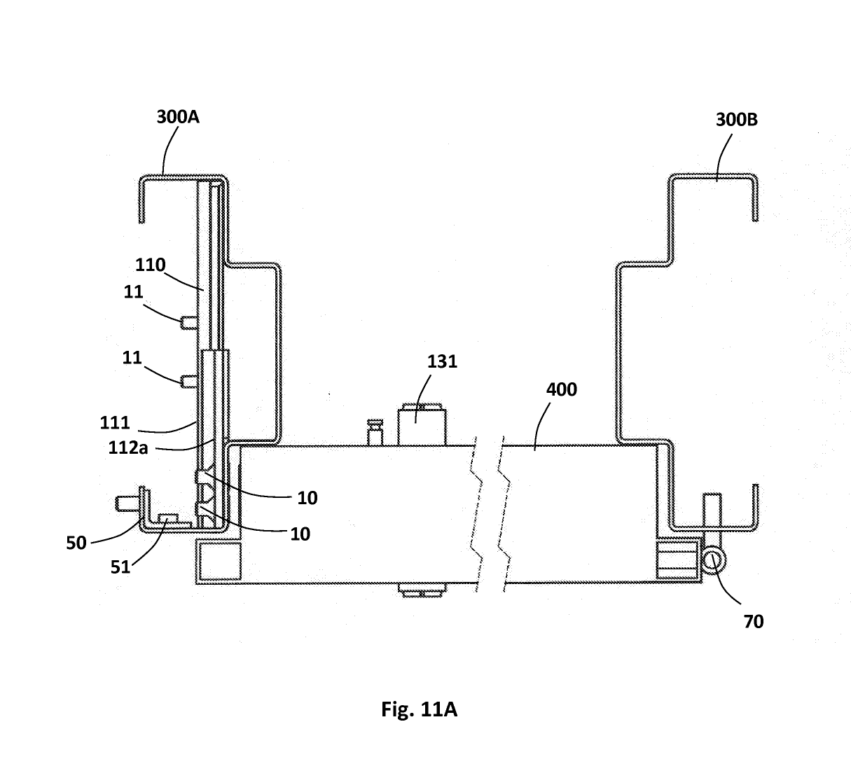

FIG. 7 shows the safety lock 100 installed at a doorframe 300, according to some embodiments of the invention and FIG. 8 shows how an opening 310 in the doorframe 300 is created, optionally after the doorframe is affixed to a wall to accommodate the safety lock 100 therein, according to some embodiments of the invention. According to these embodiments, the first lock member 110 is installed inside a niche created by the opening 310 by for example, first inserting the tracks 112a and 112b and fastening them to the doorframe 300 through screw fasteners 10 and then sliding the movable element 111 therethrough into the niche in the doorframe 300 and securing the first lock member 110 therein through a securing element 50 attaching it to the doorframe 300 via fasteners such as screws 52. The securing element 50 can block the movement of the protruding section 122 as well as prevent tilting of the protruding section 122 inside the doorframe 300 for preventing attempted pulling thereof from the niche of the doorframe 300. As illustrated in FIG. 8, to install the first lock member 110 inside the doorframe 300 the doorframe 300 is first perforated to create an opening therein 310 and then other openings such as threaded screw-openings 301 may be perforated in the doorframe 300 for allowing securing the fasteners 10 of the first lock member 110 therein. The security element may also include a salience 51 as illustrated in FIG. 10, for further block the movement of the protruding element 122. The opening 310 of the doorframe 300 is completely sealed by the first lock member 110 installation.

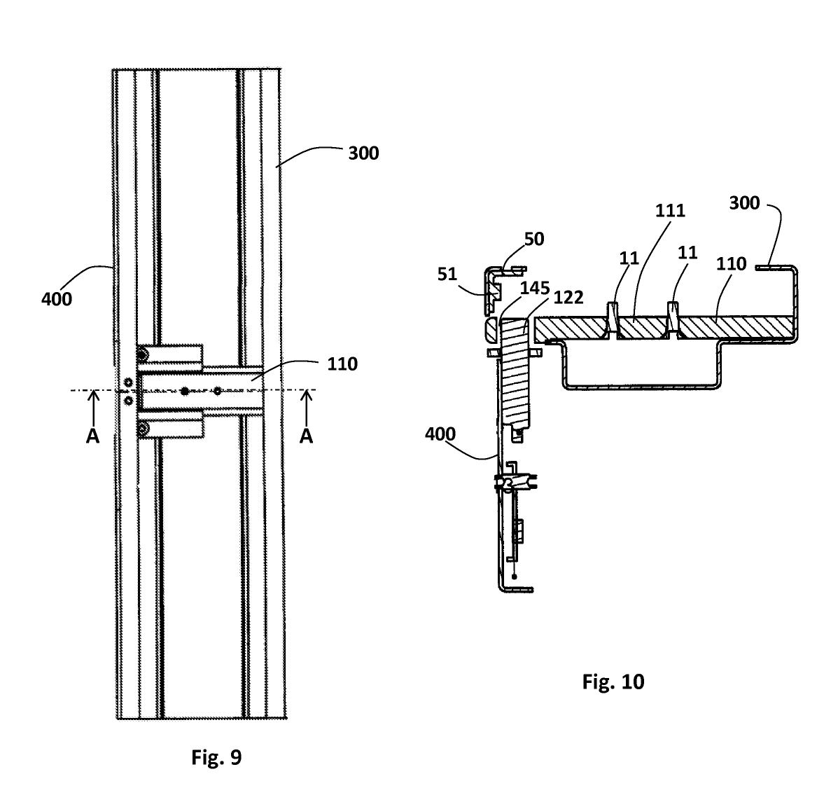

FIG. 9 shows a rear view of the doorframe 300 and the first member 110 installed therein, when a door 400 is in a closed position in respect to the doorframe 300 according to some embodiments of the invention and marks cross section A-A shown in FIG. 10. It is clear form FIG. 10 that when the door is fully closed and the safety lock 100 is in a locked position, the protruding section of the second lock member 120 is inserted through the opening 114 of the first lock member 110 and that the stoppers 11 prevent the movable element 111 thereof from completely exiting the doorframe 300 when pulled outwardly by opening the door in this position. The stoppers 11 are configured to limit the exiting of the movable element 111 by being blocked by the inner walls of the doorframe 300 as they protrude from the surface of the movable element 111.

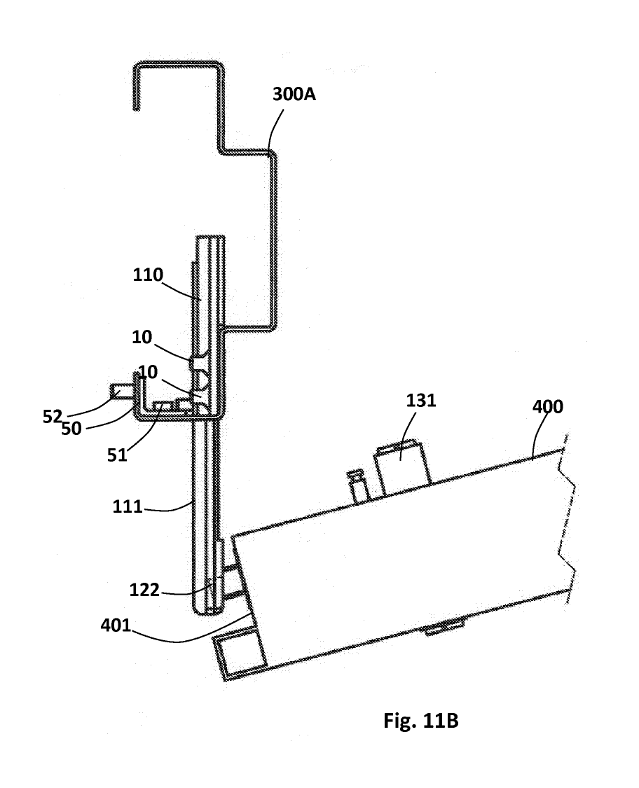

FIG. 11A shows the safety lock 100 installed in a door-set including two doorframes 300A and 300B and a door 400, where the door 400 is in a closed position and the safety lock 100 is in a locked yet un-pulled position, according to some embodiments of the invention. To pull the movable element 111 of the first lock member 110, the user has to open the door 400 by rotating it in respect to the second doorframe 300B to which it pivotally connects through one or more hinges such as hinge 70.

FIG. 11B shows a semi-transparent view of the doorframe 300A and the first and second lock members 110 and 120 of the safety lock 100, according to some embodiments of the invention, wherein the door 400 is opened and held at a partially open position by the safety lock 100 since the protruding section 122 of the second lock member 120 is interlocked with the movable element 111 and pulls it away from the doorframe 300A until it reaches its maximal length and held by the stoppers 11 thereof to enable holding the door in that partially open position for preventing passing through this door space.

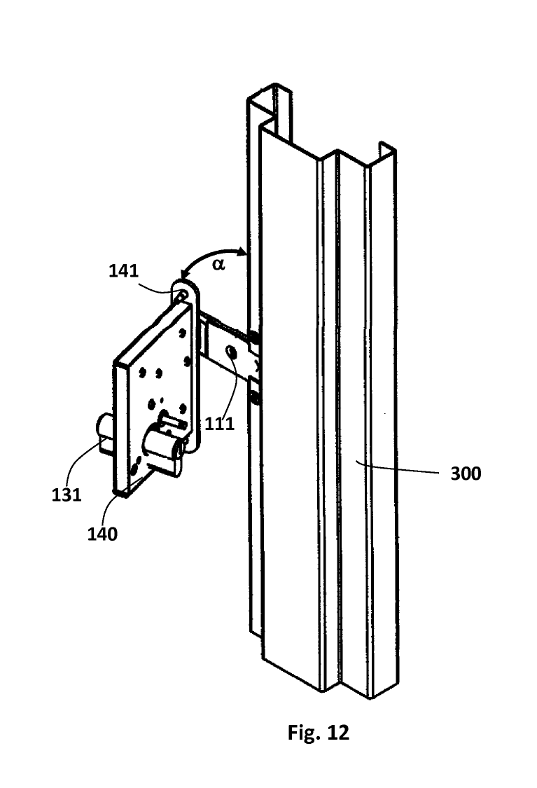

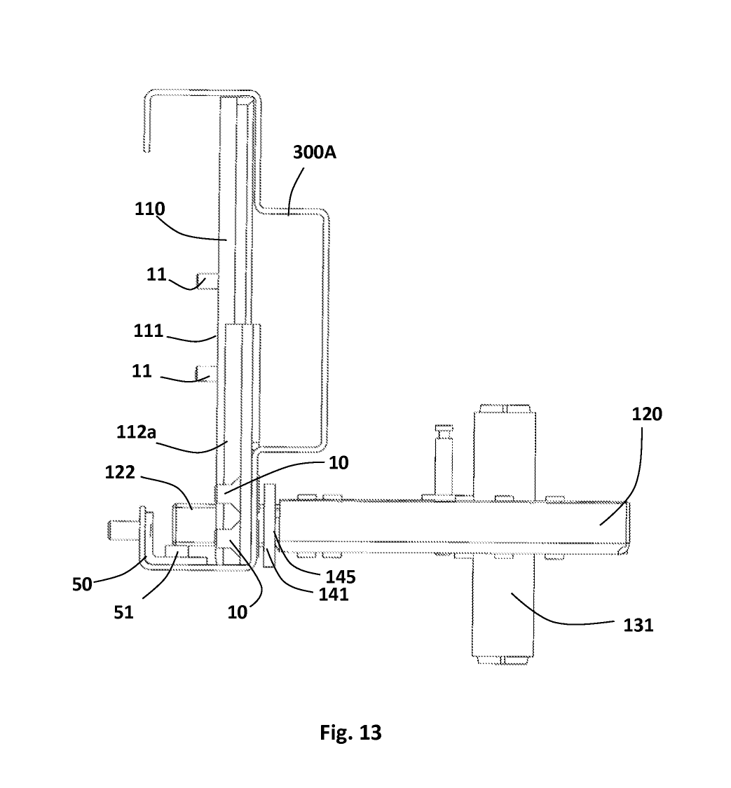

FIG. 12 shows the safety lock 100 in a partially open position in which the movable element 111 of the first lock member 110 is pulled to its maximal length and therefore allows a maximal opening angle “a” of the door 400 in respect to doorframe 300A, according to some embodiments of the invention.

The components of the safety lock 100 may be made from any one or more types of solid materials known in the art such as iron or any other metallic material, solidified polymeric materials and the like or a combination thereof. The components are configured for easy installation and therefore also enable easy replacement of each one thereof as they do not require removal of the doorframe or the door for installation or replacement thereof.

FIG. 13 shows the safety lock 100 in a fully locked position in which the door in which the second lock member 120 is installed, cannot be opened to an open or a semi-open position, since the protruding section 122 is fully inserted through the opening 145 of the doorframe 300A and the opening 114 of the first lock member 110. The salience 51 of the securing element 50 that is installed at the doorframe 300A is positioned to prevent the protruding section 122 from being pulled from the opening 114 of the first lock member 100 by tilting of the door (not shown).

According to some embodiments of the present invention, the safety lock is also configured to allow a fully-locked position of the door in which the door cannot be open even to a partial open position for allowing this lock to provide an all-inclusive locking solution providing a regular door lock combined with a safety lock for partial locking This can be done by having a mechanism inside the doorframe, where the first lock member is installed, that can lock the protruding section of the second lock member of the safety lock therein when the key is further rotated in the key lock.

According to other embodiments of the invention, the transmission mechanism does not include cogwheel solution but a different mechanical configuration and components that allow mechanically linearly pulling and pushing of the second lock member.

According to some embodiments of the invention, the first lock member of the safety lock can be installed externally from the doorframe such as over a wall over which the doorframe is installed but not inside the doorframe also installing a blocking element for blocking the movement of the movable element by blocking its one or more stoppers, for example.

According to yet other embodiments of the invention, the first lock member includes a single track that interlocks with the recesses of the movable element, allowing insertion thereof into the niche in the doorframe separable from the movement element.

According to other embodiments of the invention, the safety lock includes only the first and second members having another type of transmission mechanism that allows locking and unlicking of the safety lock by mechanically moving the protruding section of the second lock member to protruding and retreated positions for locking and unlocking of the safety lock, respectively. For example, instead of a key lock transmission mechanism requiring a gear set having cogwheels, the transmission mechanism includes a simple protrusion movable inside a groove of the second lock member for physically moving thereof to have the protruding section protrude from the opening thereof and for retracting it back to an non-protruding position.

According to some embodiments, the side of the doorframe that includes the opening for receiving the first lock member and the side of the door at which the second lock member is installed are configured such that the distance between them is minimal when they door is closed. This distance depends on the quality of the door and doorframe material and can change (deform) when under heat and other erosive conditions over time.

According to some embodiments of the invention, for embodiments of the safety lock that include a lock transmission mechanism that enables three positions of the safety lock: (i) a fully open position; (ii) a semi-open position; and (iii) a fully locked position, the transmission mechanism may also include a security mechanism configured for detaching the transmission mechanism (e.g. lock and gear set) from the second lock member when the safety lock is in the semi-open position. This security mechanism may be added to prevent an unauthorized person from unlocking the semi-open position from behind the door and ensures that only the person inside the premises/house can re-attach the transmission mechanism for fully locking/opening of the safety lock.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A safety lock for enabling partial opening of a door, said safety lock comprising:
a first lock member configured for being installed at an opening of a doorframe of the door, said first lock member comprising a movable element and at least one track for allowing said movable element to slide therethrough, said movable element comprises an opening; and
a second lock member comprising a protruding section, wherein said protruding section is configured for being inserted into said opening of said first lock member, installed at said doorframe, and for pulling said movable element for partial opening of the door and removing said protruding section from said opening for opening the door; and
wherein each said track is separable from said movable element to allow installation of said first lock member inside the doorframe by inserting each of said movable element and said tracks separately through the doorframe opening.

2. The safety lock according to claim 1, wherein said movable element includes at least one stopper configured for preventing said movable element from completely being removed from the doorframe.

3. The safety lock according to claim 1 further comprising a transmission mechanism configured for pulling and pushing of said second lock member for locking and unlocking of said safety lock.

4. The safety lock according to claim 3, wherein said transmission mechanism comprises a key lock.

5. The safety lock according to claim 4, wherein said transmission mechanism further comprises a set of cogwheels for allowing transforming a rotational movement of a key rotating said key lock into linear movement of said second lock member for locking and unlocking said safety lock.

6. The safety lock according to claim 1 further comprising a holding base that holds said second lock member and said transmission mechanism thereover, said holding base is configured to be installed inside the door.

7. The safety lock according to claim 6, wherein said second lock member has a groove opening therein and said holding base comprises at least one pin inserted through said groove.

8. The safety lock according to claim 1, wherein said at least one track comprises two tracks each meshing with a side of said movable element for allowing said movable element to slide therethrough.

9. The safety lock according to claim 8, wherein each said track is fastened to said doorframe via at least one fastener thereof.

10. The safety lock according to claim 1, wherein said movable element fully covers the opening in the doorframe when the door is closed.

11. A safety lock for enabling partial opening of a door, said safety lock comprising:
a first lock member configured for being installed at an opening of a doorframe of the door, said first lock member comprising a movable element and at least one track for allowing said movable element to slide therethrough, said movable element comprises an opening;
a second lock member comprising a protruding section connected to a base section of said second lock member, wherein said protruding section is configured for being inserted into said opening of said first lock member, installed at said doorframe, for thereby pulling of said movable element for allowing partial opening of said safety lock and removing said protruding section from said opening for opening said safety lock; and
a transmission mechanism configured for pulling and pushing of said second lock member for locking and unlocking of said safety lock, wherein each said track is separable from said movable element to allow installation of said first lock member inside the doorframe by inserting each of said movable element and said tracks separately through the opening thereof.
